(19) United States
(12) Patent Application Publication
(10) Pub. No.: US 2001/0038433 A1
(43) Pub. Date: Nov. 8, 2001

(54) Display device and method of manufacturing such a display device

(76) Inventors: Herbert Lifka, Eindhoven (NL); Michel Jan Maria Bruyninckx, Eindhoven (NL)

Correspondence Address: Corporate Patent Counsel, U.S. Philips Corporation, 580 White Plains Road, Tarrytown, NY, 10591, US

(21) Appl. No.: 09/817,980

(22) Filed: Mar. 27, 2001

(30) Foreign Application Priority Data
Apr. 3, 2000 (EP) 00201204.5

(51) Int. Cl. G02F 1/1343

(52) U.S. Cl. 349/142

(57) ABSTRACT

Spacing between electrode segments is minimized, e.g. by CAD design to obtain the lowest electrical resistance of said electrodes.

The invention relates to a display device comprising a first substrate which is provided with a conductor pattern, parts of which define pixels. The invention also relates to a method of manufacturing such a display device.

Display devices of the type described, particularly electroluminescent display devices, based on (organic) LEDs find an ever wider application in, for example, measuring equipment but also in, for example, portable telephones. Liquid crystal display devices are also very generally used in this field.

The invention also relates to a method of generating a conductor pattern for such a display device.

When using notably segmented electrodes in organic LEDs (for example, polymer LEDs), light is generated in the LED by supplying it with a (constant) current. The required energy must be supplied via connection conductors which form part of said conductor pattern. As these conductors have a higher resistance, more (superfluous) energy is dissipated therein. Moreover, the supply conductors are usually visible.

The problem of a too high resistance in the supply conductors also occurs in, for example, display devices based on switchable mirrors.

In the case of similar use of segmented electrodes in liquid crystal display devices (LCDs), the light is modulated in dependence upon the voltage across the electrodes. Due to leakage currents and charge effects, a too high resistance of the connection conductors causes an incorrect setting of the control voltage defining the intensity of the transmitted or reflected light.

It is, inter alia, an object of the present invention to provide a solution to the above-mentioned problem. To this end, a display device according to the invention is characterized in that, at least within a viewing area of the display device, the conductor pattern, viewed transversely to the substrate, substantially completely covers the corresponding part of the first substrate.

In this application, the words “substantially completely” are understood to mean that the finished conductor pattern fills at least 80% (and preferably 90% or more) of the viewing area.

The invention is based on the recognition that said conductor pattern can be subjected to a maximum distance between parts thereof so that this conductor pattern is interrupted on a minimal surface area in the viewing area.

Said maximum distance as well as the minimal surface area are dependent, inter alia, on process parameters such as layer thicknesses and etching parameters, but particularly on the tolerances of the photolithographic process which define the minimally permissible distance between parts of the conductor pattern.

In the case of use in polymer LEDs or organic LEDs, a great design of freedom is obtained for, for example, the anode contacts. If a multiplex circuit is realized, the same applies to the cathode contacts, notably when the actual segments are defined by means of windows in an insulating layer.

In LCDs, pixels are defined by overlap of electrodes on two facing substrates between which a liquid crystalline material is present. If the conductor pattern substantially completely covers the corresponding part of a first substrate, unwanted overlap may occur of parts of the conductor pattern (ITO) and parts of a conductor pattern on the other substrate. However, it appears that an optimal coverage with conductor patterns (ITO) of both substrates is also possible in this case by causing the partitioning paths at the area of a separation between two segments to substantially coincide on both plates, as viewed perpendicularly to the substrates. Any unwanted switching behavior then almost exclusively takes place along the edges of the segments and is not visible or hardly visible.

The maximum distance between parts of the conductor pattern is defined in that parts of the conductor pattern are mutually separated by partitioning paths having a minimal path width. As stated, this distance depends on process parameters but particularly on the tolerances of the photolithographic process used. The minimal path width is usually so small (<25 μm) that the separation between the parts of the conductor pattern is not visible or hardly visible.

Although the words “minimal path width” are used in this context, it will be evident that this minimal path width will not have a constant value in practice but may locally vary to some extent due to the influence of, for example, etching rates, dust particles, or other influences. In practice, there will thus be an average.

The partitioning paths preferably have at least locally a curved course. It appears that this does not only minimize the partitioning paths within the pattern but also has technological advantages.

A method according to the invention is characterized in that

1) the following elements are defined: the position of connection contacts, the pixels to be displayed and the viewing area of the display device;

2) the minimal path width between parts of the conductor pattern is introduced on the basis of process parameters;

3) based on items 1) and 2), the conductor pattern of mutually separated conductor parts is computed by means of a computing program, defining at least the required connections between connection contacts and pixels and substantially completely filling the viewing area.

In the same computer program, a conductor pattern is preferably computed for a counter electrode, defining at least the required connections between connection contacts and the counter electrodes and substantially completely filling the viewing area. In LEDs, the counter electrodes are the cathodes and the anodes, respectively, when the connections of the anodes and the cathodes are first computed by means of the computer program. In LCDs or other electro-optical display devices such as, for example, electrochromic display devices, the conductor pattern is usually first defined for the pixels and then for counter electrodes which are common for a plurality of pixels. In this case, multiplexing is generally used; this is also possible in the case of (O) LEDs.

These and other aspects of the invention are apparent from and will be elucidated with reference to the embodiments described hereinafter.

In the drawings,

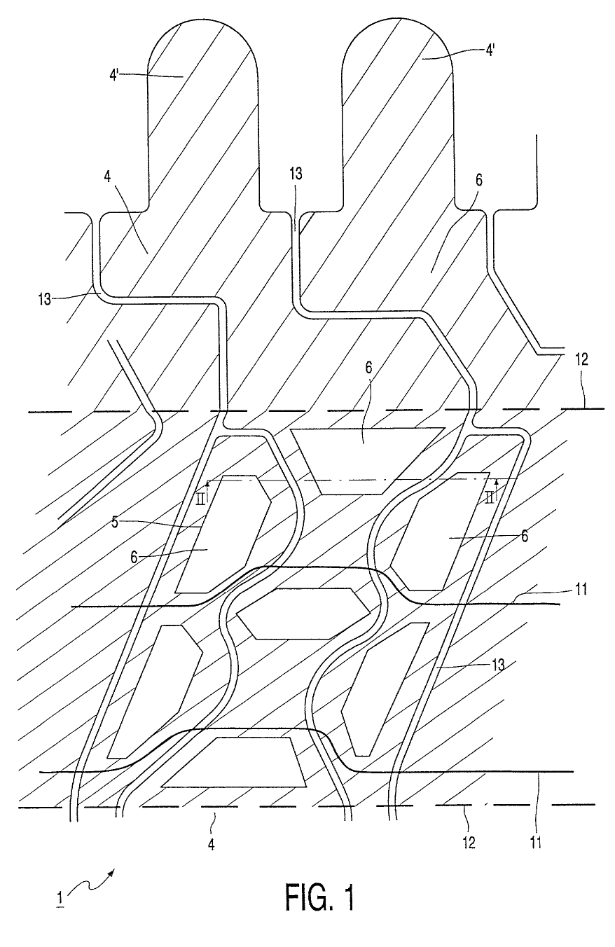

FIG. 1 is a diagrammatic plan view of a plane through a part of a device according to the invention,

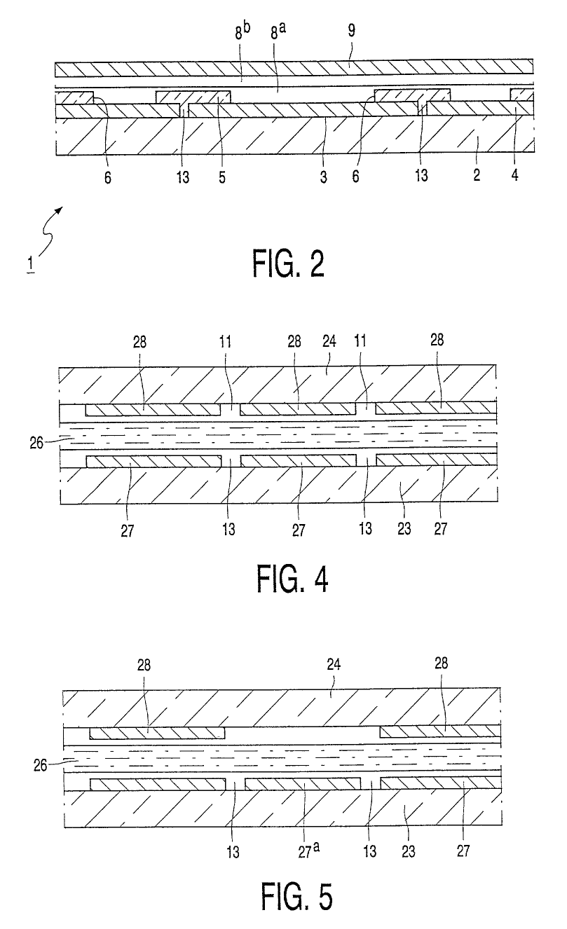

FIG. 2 is a cross-section taken on the line II-II in FIG. 1,

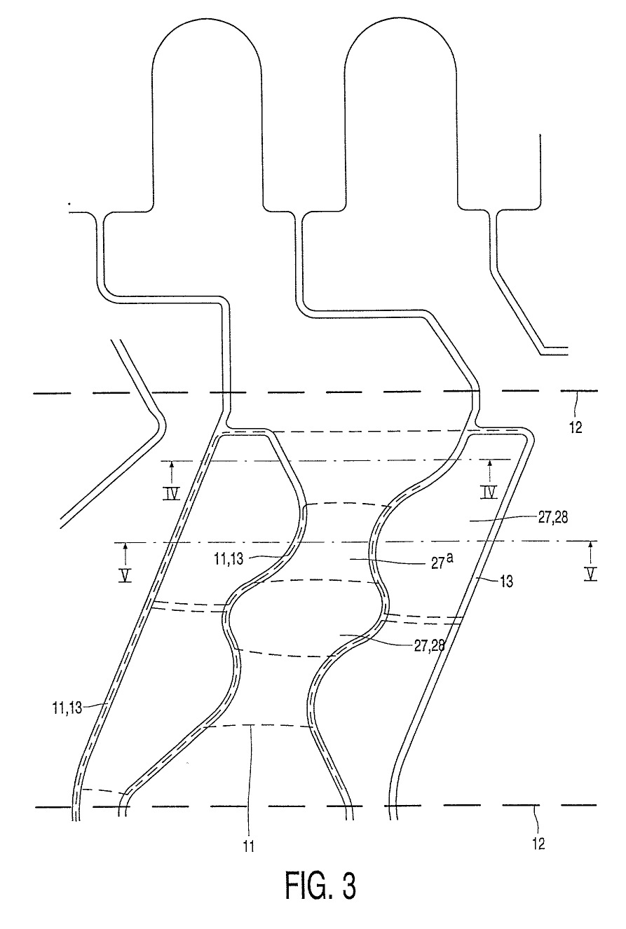

FIG. 3 is a diagrammatic plan view of a plane through a part of another device according to the invention,

FIG. 4 is a cross-section taken on the line IV-IV in FIG. 3,

FIG. 5 is a cross-section taken on the line V-V in FIG. 3, while

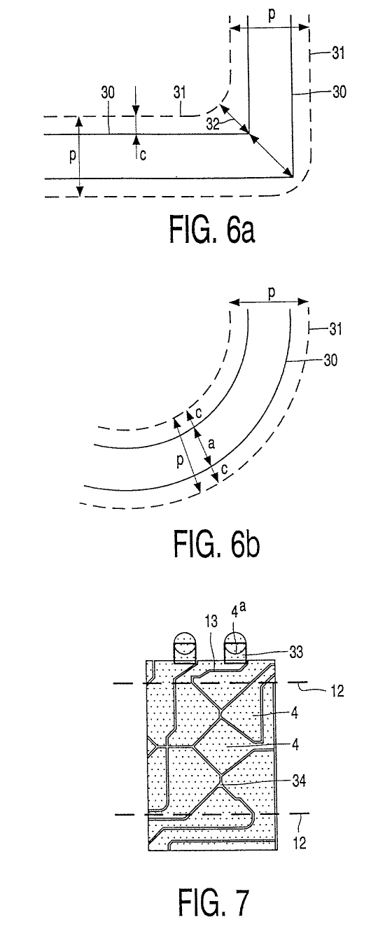

FIG. 6 shows some plan views during manufacture of a part of a device according to the invention, and

FIG. 7 shows a further variant with reference to which the method is described.

The Figures are diagrammatic and not drawn to scale. Corresponding elements are generally denoted by the same reference numerals.

FIG. 1 is a diagrammatic plan view of a part of a display device 1 based on electroluminescence. This device (FIG. 2) comprises a transparent substrate 2 of, for example, glass, a surface 3 of which is provided with a first, transparent electrode layer 4, in this example a conventional, approximately 150 nm thick, structured layer of ITO (indium tin oxide). The ITO electrodes define, inter alia, the contacts with pixels and the connection tracks 4, 4′. If necessary, the connection tracks 4, 4′ are coated at suitable areas with a layer of low-ohmic material. The first electrode layer 4 is provided with a layer 5 of an insulating material having contact apertures 6. This layer is provided with an electroluminescent material 8, for example, semiconducting organic luminescent material. In this example, the layer 8 is composed of two sub-layers 8^{a}, 8^{b} of, for example, poly(p-phenylene vinylene) or PPV and polyethylene dioxythiophene (PEDOT).

The layer of electroluminescent material is provided with a second electrode layer 9. The electrode layers 4, 9 and the intermediate electroluminescent material 8 jointly constitute light-emitting diodes or LEDs, in which, for example, the ITO layer 4 functions as an anode contact, while the electrode layer 9 functions as a cathode contact.

In the plan view of FIG. 1, the lines 11 indicate that the electrode layer 9 (the cathode contact) may be split up into, for example, three sub-electrodes so that multiplexing (here 1:3 multiplexing) is possible. The broken lines 12 diagrammatically indicate the border of the actual viewing area. In an application such as, for example, a mobile telephone, these coincide with a window through which the display device is visible.

During selection, a cathode contact receives a sufficiently negative voltage so that the LEDs connected thereto and controlled (for example) via current sources have the desired current feedthrough. Since the device does not convey current at the area of the layer 5 of insulating material, the luminescent material only luminesces in the areas defined by the contact apertures 6.

According to the invention, the substrate is substantially completely coated by the conductor pattern 4 within the viewing area bordered by the broken lines 12, while the conductor pattern 9 within this viewing area also covers the complete device, with the exception of partitioning paths 13. The conductor parts are designed in such a way that the partitioning paths 13 have a minimal width substantially throughout (defined by tolerances of the manufacturing process, such as minimal mask distance, layer thicknesses, etching properties, etc.). At the location of the lines 11, the electrode layer 9 is split up into three sub-electrodes by similar partitioning paths with a minimal path width. It is thereby achieved that the connection tracks 4, 9 have a minimal resistance. For a minimal resistance, the device is covered as much as possible with the conductor pattern 4, 9 also outside the viewing area.

FIG. 3 is a plan view of an (alphanumerical) liquid crystal display device. In this example, the liquid crystal display device is shown in a simplified form by means of two transparent substrates 23, 24 between which a layer of liquid crystalline material 26 is present. In this example, the liquid crystal display device is of the transmissive type. For defining pixels, the display device in this example comprises transparent electrodes 27 on the substrate 23 and electrodes 28 on the substrate 24. These electrodes are coated with orienting layers 29. For the sake of simplicity, further elements such as, for example, polarizers and drive electronics are not shown in FIGS. 4, 5. Within the viewing area bordered by the broken lines 12, the substrate 23 is substantially completely covered by conductor pattern 27, with the exception of partitioning paths 13 having a minimal path width. The counter electrodes 28 on the substrate 24 preferably cover a maximal part of this substrate and are mutually separated by partitioning paths 11 having a maximal path width which, viewed transversely to the substrate, substantially coincide on both plates at the area of a partition between two segments. Possibly unwanted switching behavior then substantially exclusively takes place along the edges of the segments and is not visible or hardly visible. Parts of the substrate 24 (for example, opposite electrode 27^{a}) in FIG. 5 are not covered with an electrode in the example of FIGS. 3, 4, 5, but this does not always have to be detrimental. For a uniform thickness of the layer of liquid crystalline material 26, an unconnected electrode may be provided, if necessary, again with partitioning paths having a minimal path width between this electrode and the electrodes 28.

The partitioning paths 11, 13 have a curved variation, which has advantages as is shown diagrammatically in FIG. 6. In FIG. 6^{a}, the reference numeral 30 denotes an ideal mask pattern for providing a layer of photoresist, with a subjacent material (for example, electrode material in the above-mentioned examples) at the location of a corner. The photoresist etchant evenly penetrates below this layer of photoresist (arrows 31) and thus defines the maximal path width p between two electrodes on the straight sections, while in a subsequent etching step all material outside the photoresist is etched off (arrow 31). However, in the corner, notably on the inner side (arrows 32) much more etchant is etched off so that the partition between the electrodes 4 and 4′ is more over a large distance than said minimal path width p of the partitioning paths. With a curved shape of the partitioning paths (FIG. 6^{b}), the difference in the radius of curvature between the two edges of the mask is usually so small that this does not give rise or hardly gives rise to local widening of the partitioning paths. The surface areas are then maximally filled up with electrode material.

FIG. 7 once again shows a metallization pattern for a display device. According to the invention, this device is designed by defining the position of connection contacts 4^{a} (with extra metallization 33, if necessary); this is usually dependent on the application (for example, the number of connections to be used), the pixels to be displayed (for example, the apertures 6 in FIGS. 1, 2); this is usually also dependent on the application (for example, the pixels to be displayed, icons, etc.). The viewing area of the display device, as indicated by the lines 12, is usually also dependent on the casing of the device.

This information, together with the minimal path width of the paths 13 between parts 4 of the conductor pattern (as defined by process parameters) is introduced in a computer program which, based on this information, computes a conductor pattern of mutually separated conductor parts defining the required connections between connection contacts and pixels and substantially completely covering the viewing area. Subsequently, another program or a part of the same program is used for computing the resistance of the different connections, whereafter the ultimate pattern is defined, if necessary, in some optimizing layers.

Suitable programs are, for example, computer programs for computing wiring patterns on an IC, where the intermediate space is chosen to be as large as possible so as to prevent capacitive crosstalk. Where these programs normally define the location of the conductor tracks, they are now used for maintaining the space between the metal tracks as narrow as possible, while the intermediate space to be filled with electrode material is chosen to be as large as possible.

The invention is of course not limited to the embodiments shown, but several variations are possible. For example, it will not always be possible to maintain the same distance between the electrodes throughout the surface area or to substantially completely cover the surface area with electrode material (as in, for example, the area 34 in FIG. 7). However, practical limits do not prevent the finished conductor pattern from covering at least 80% (and in practice 90% or more) of the viewing area. At least 80% (and in practice 90% or more) of the partitioning paths has a minimal width.

The protective scope of the invention is not limited to the embodiments shown. The invention resides in each and every novel characteristic feature and each and every combination of characteristic features. Reference numerals in the claims do not limit their protective scope. The use of the verb “to comprise” and its conjugations does not exclude the presence of elements other than those stated in the claims. The use of the article “a” or “an” preceding an element does not exclude the presence of a plurality of such elements.

1. A display device comprising a first substrate provided with a conductor pattern, parts of which define pixels, characterized in that, at least within a viewing area of the display device, the conductor pattern, viewed transversely to the substrate, substantially completely covers the corresponding part of the first substrate.

2. A display device as claimed in claim 1, characterized in that the parts of the conductor pattern are substantially mutually separated by partitioning paths having a minimal path width.

3. A display device as claimed in claim 2, characterized in that the partitioning paths have a substantially constant width.

4. A display device as claimed in claim 2 or 3, characterized in that the partitioning paths at least locally have a curved course.

5. A display device as claimed in claim 2 or 3, characterized in that at least 80% of the partitioning paths has a minimal path width.

6. A display device as claimed in claim 1, characterized in that it comprises a light-emitting material between two conductor patterns, at least one of which, viewed transversely to the substrate, substantially completely covers the corresponding part of the first substrate.

7. A display device as claimed in claim 1, characterized in that it comprises a layer of electro-optical material between two conductor patterns on a first and a second substrate, at least one of which conductor patterns, viewed transversely to the substrate, substantially completely covers the corresponding substrate.
